(19) United States
(12) Patent Application Publication
(10) Pub. No.: US 2009/0224015 A1
(43) Pub. Date: Sep. 10, 2009

(54) Accessory Pouch

(76) Inventor: Philip A. Jones, Hamilton (BM)

Correspondence Address: WILSON DANIEL SWAYZE, JR., 3804 CLEARWATER CT., PLANO, TX, 75025, US

(21) Appl. No.: 12/044,160

(22) Filed: Mar. 7, 2008

(51) Int. Cl. B62J 9/00

(52) U.S. Cl. 224/413; 224/412

(57) ABSTRACT

A pouch for being used with a rigid saddle bag may include a first end panel, a second end panel, a top panel between the first and panel and the second end panel, a bottom panel between the first and panel and the second end panel, a first and second substantially L-shaped side panel between the top and bottom panels. The rigid saddlebag may include a projecting member to define a first storage area and a second storage area, and the pouch and may be adapted to fit within the first storage area or the second storage area of the rigid saddlebag. The projecting member may include a longitudinal portion, and the projecting member may include a traverse portion. The pouch may be deformable, and the pouch may include an opening to an interior area of the pouch. The pouch may be formed from leather, and the pouch may be formed from plastic or vinyl. The pouch may have approximately the same dimensions as the storage area.

### TECHNICAL FIELD

This invention relates to cycle vehicles and, more particularly, to saddlebags arrangements therefore.

### BACKGROUND ART

The number of people experiencing the enjoyment of touring on bicycles, mopeds or motorcycles has been steadily increasing over the years. Cycles have replaced the use of automobiles for traveling to work, school, the grocery store and other places where it is necessary for the rider to carry various objects on the cycle to and from his destination. Panniers, as they are referred to in the trade, may take various forms such as saddlebags, packs, baskets and the like.

Saddlebags are particularly useful for motorcycle touring over an extended period of time. Some Saddlebags take the form of rigid containers affixed to the rear sides of the motorcycle. These constructions, unfortunately, unduly increase the weight of the cycle and are not readily removable. Many known arrangements also require semi-permanent attachment of large amounts of hardware to the cycle.

To overcome this problem, it would be highly advantageous to employ a lightweight saddlebag arrangement that can be used both on and off the cycle as pieces of luggage without the need for distracting hardware. Unfortunately, this noteworthy objective is not easily achieved. Such an arrangement not only requires that the saddlebags be removably attached to the cycle, but they also must be mounted in such a manner that they do not impede safe operation of the motorcycle or comfort of the passenger. Flexible, lightweight saddlebags have their advantages because it is easy to manually carry them after removal from the cycle. However, they are ordinarily not designed to withstand the road abuse and their flexible sides may interfere with the spokes of the rear wheel when hanging from the side of the seat. It is also difficult to load/unload flexible bags because of their tendency to sag. Additionally, the load distribution of the objects in the bag may become uneven, resulting in an unpredictable sway of the bag caused by shifts in the load.

Finally, it is of importance that the saddlebags be securely fastened to the cycle and remain in a stable position when encountering the high wind forces typically experienced at highway speeds. The saddlebag mounting arrangement not only must accomplish this objective but it also would be highly desirable to employ a mounting arrangement that could be used on a variety of different cycle constructions without requiring substantial modifications of the cycle to effectuate the saddlebag mounting arrangement.

U.S. Pat. No. 4,580,706 discloses that the saddlebag includes a cutaway in the forward lower corner portion thereof to provide a heel clearance for a passenger on the cycle. A substantially solid panel is affixed to the interior rear of the bag and an elongated attachment plate is provided on the exterior rear of the saddlebag. A U-shaped bar pivotally mounted to the interior panel is advantageously employed as part of the internal frame construction for the bag. The bags are mounted on the cycle by way of a first pair of straps secured to spaced locations on the seat and a second pair of straps removably connected thereto. The ends of the straps of the second pair are detachably secured to the attachment plate on the saddlebags. A rigid strap mounted to a fixed part of the cycle is adapted to receive a connector extending from the lower front side of the saddlebag. A rear strap connecting the rear portions of a pair of saddlebags is also provided. Each saddlebag may include detachable exhaust/abrasion shields.

U.S. Pat. No. 6,068,095 discloses a saddle bag insert 10 for use with a soft sided saddle bag 100 having front 101 and rear 102 end panels, a pair of side panels 103, 104 and a floor panel 105. The saddle bag insert 10 includes an insert member 20 fabricated from an elongated, thin, flat, contoured strip of rigid yet flexible material 21 having an intermediate segment 22 and a pair of end segments 23, 24 that are adapted to resiliently conform to the contours of the front and rear end panels 101, 102 and the floor panel 105 to provide rigidity to the soft sided saddle bag 100.

U.S. Pat. No. 6,068,075 discloses a saddle bag provided at least on one side of a rear wheel, the saddle bag is supported on the body frame and protected using a reduced number of required parts, thus increasing design freedom. A guard pipe extends outside beyond the saddle bag and is mounted to the body frame. At least a portion of the saddle bag is fixedly supported by the guard pipe.

U.S. Pat. No. 4,629,040 discloses a rigid insert is provided in a soft luggage shell. The insert conforms to the configuration of the inside luggage surface and is removably held in place by a twistable retainer ring. The ring is encased in a cloth sleeve and mounted to the luggage in the vicinity of an edge of the insert. By twisting the ring, the ring and associated sleeve can be selectively placed either abuttingly against the insert or away from the insert to allow its removal. The invention also contemplates the provision of a protective shield which is removably mounted to a surface of the luggage which abuts a carrying vehicle.

### SUMMARY

A pouch for being used with a rigid saddle bag may include a first end panel, a second end panel, a top panel between the first and panel and the second end panel, a bottom panel between the first and panel and the second end panel, a first and second substantially L-shaped side panel between the top and bottom panels.

The rigid saddlebag may include a projecting member to define a first storage area and a second storage area, and the pouch and may be adapted to fit within the first storage area or the second storage area of the rigid saddlebag.

The projecting member may include a longitudinal portion, and the projecting member may include a traverse portion.

The pouch may be deformable, and the pouch may include an opening to an interior area of the pouch.

The pouch may be formed from leather, and the pouch may be formed from plastic or vinyl.

The pouch may have approximately the same dimensions as the storage area.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the bottom section of the rigid saddlebag;

FIG. 2 illustrates a side view of the bottom section of the rigid saddlebag;

FIG. 3 illustrates a top view of the top section of the rigid saddlebag;

FIG. 4 illustrates a top view of the first L-shaped deformable pouch;

FIG. 5 illustrates a top view of the second L-shaped deformable pouch;

FIG. 6 illustrates a bottom view of the first L-shaped deformable pouch;

FIG. 7 illustrates a bottom view of the first L-shaped deformable pouch;

FIG. 8 illustrates a side view of the first L-shaped deformable pouch;

FIG. 9 illustrates a side view of the second L-shaped deformable pouch;

FIG. 10 illustrates a side view of the first L-shaped deformable pouch;

FIG. 11 illustrates a side view of the second L-shaped deformable pouch;

FIG. 12 illustrates a top view of the rigid saddlebag with the first and second L-shaped deformable punches;

FIG. 13 illustrates a top view of a third L-shaped deformable pouch;

FIG. 14 illustrates a top view of a fourth L-shaped deformable pouch;

FIG. 15 illustrates a bottom view of the third L-shaped deformable pouch;

FIG. 16 illustrates a bottom view of the fourth L-shaped deformable pouch.

### DETAILED DESCRIPTION

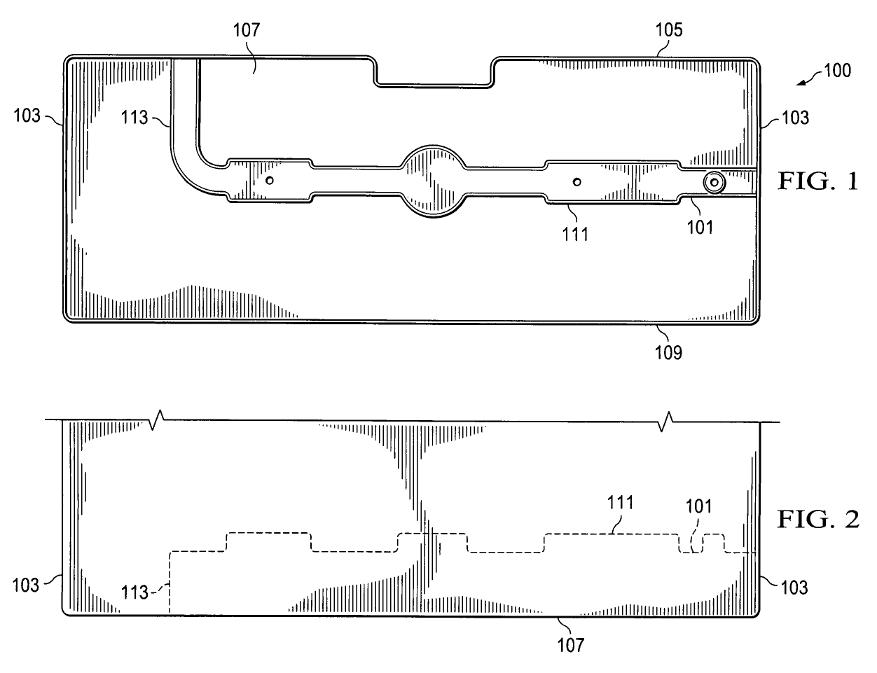

FIG. 1 illustrates a top view of the bottom section of a rigid saddlebag 100. The rigid saddlebag 100 includes end wall 103 on each opposing end of the rigid saddlebag 100, a front wall 105, a back wall 109 and a bottom wall 107. FIG. 1 additionally illustrates a projecting member 101 which extends upwards from the bottom wall 107. The projecting member 101 includes a longitudinal portion 111 which extends approximately longitudinally in the center of the bottom wall 107 and includes a traverse portion 113 which extends from one end of the longitudinal portion 111. The projecting member 101 results in a storage area that is not efficient. Objects which have been placed in a storage area will tend to move around and rattle when the vehicle is moving.

FIG. 2 illustrates a side view of the rigid saddlebag 100. FIG. 2 shows the opposing end walls 103 and the bottom wall 107. FIG. 2 additionally illustrates the projecting member 101 including the longitudinal portion 111 and the traverse portion 113.

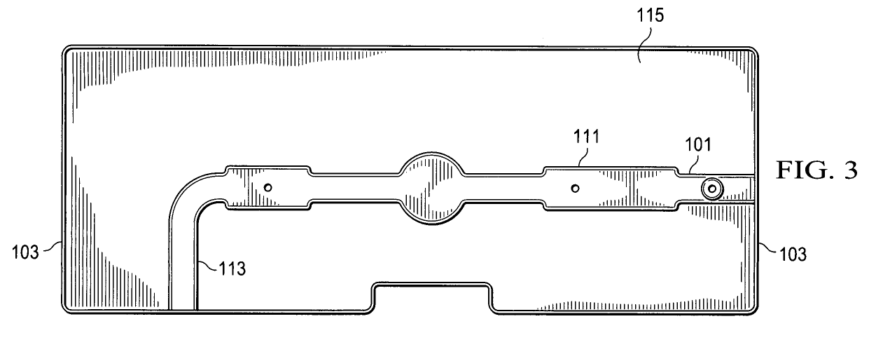

FIG. 3 illustrates a top view of the top section which cooperates with the bottom section of a rigid saddlebag 100. The rigid saddlebag 100 includes end wall 103 on each opposing end of the rigid saddlebag 100, a front wall 105, a back wall 109 and a top wall 115. FIG. 3 additionally illustrates a projecting member 101 which extends downwards from the top wall 115. The upward projecting member 101 includes a longitudinal portion 111 which extends approximately at longitudinally in the center of the top wall 115 and includes a traverse portion 113 which extends from one end of the longitudinal portion 111. The projecting member 101 results in a storage area that is not efficient.

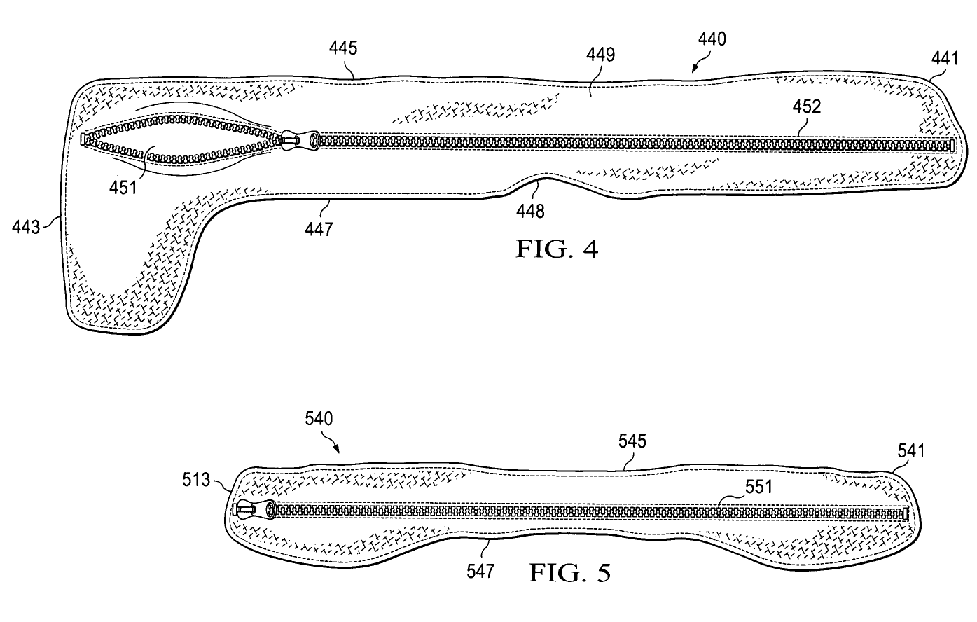

FIG. 4 illustrates a top view of a first L-shaped deformable pouch 440 which includes a hollow deformable housing which includes a front end panel 441, a back end panel 443, a top panel 445, a bottom panel 447 and a first side panel 449 which includes a closable opening 451 to allow access to the interior of the hollow housing and to allow storage of items of interest to the user of the first L-shaped deformable pouch 440. The closable opening may be closable and sealed with a sealing apparatus such as a zipper, hooks and loops (Velcro), buttons or any other suitable sealing apparatus. The bottom panel 447 includes a depression 448. Each of the front end panel 441, the back end panel 443, the top panel 445, the bottom panel number 447 and the first and second side panel 449 include a stitching line 442 around the periphery of the respective panel. The closable opening 451 may include a stitching line 452 around the periphery of the closable opening 451.

FIG. 5 illustrates a top view of a second L-shaped deformable pouch 540 which has smaller dimensions than the first L-shaped deformable pouch 440 and which includes a hollow deformable housing which includes a front end panel 541, a back end panel 543, a top panel 545, a bottom panel 547 and a first side panel 549 which includes a closable opening 551 to allow access to the interior of the hollow housing and to allow storage of items of interest to the user of the second L-shaped deformable pouch 540. The closable opening 551 may be closable and sealed with a sealing apparatus such as a zipper, hooks and loops (Velcro), buttons or any other suitable sealing apparatus.

The first and second L-shaped deformable pouch may be formed from plastic, leather, cloth, vinyl or other suitable material.

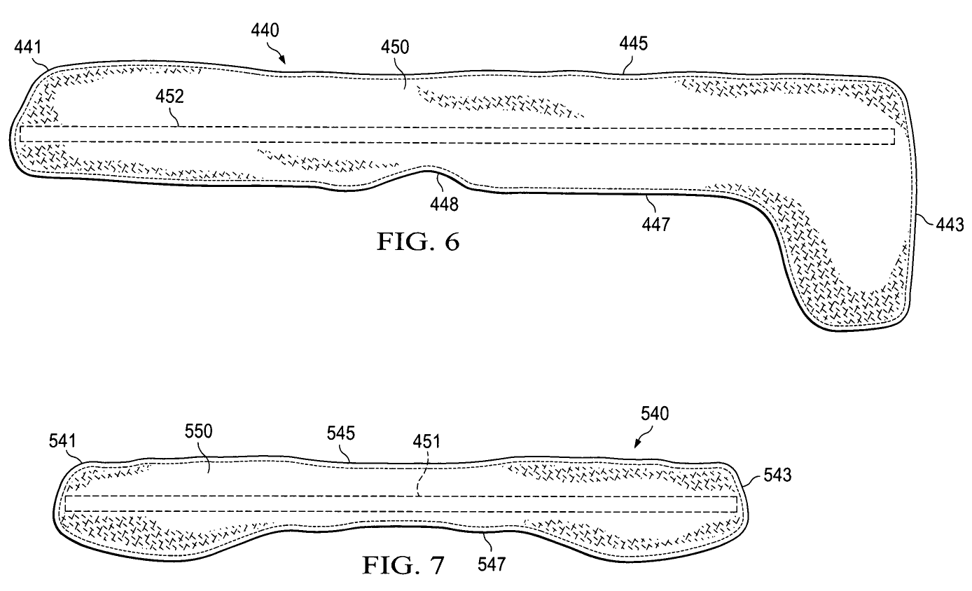

FIG. 6 illustrates a bottom view of a first L-shaped deformable pouch 440 which includes a hollow deformable housing which includes a front end panel 441, a back end panel 443, a top panel 445, a bottom panel 447 and a second side panel 450.

FIG. 7 illustrates a bottom view of the second L-shaped deformable pouch 540 which includes a hollow deformable housing which includes a front end panel 541, a back end panel 543, a top panel 545, a bottom panel 547 and a second side panel 550.

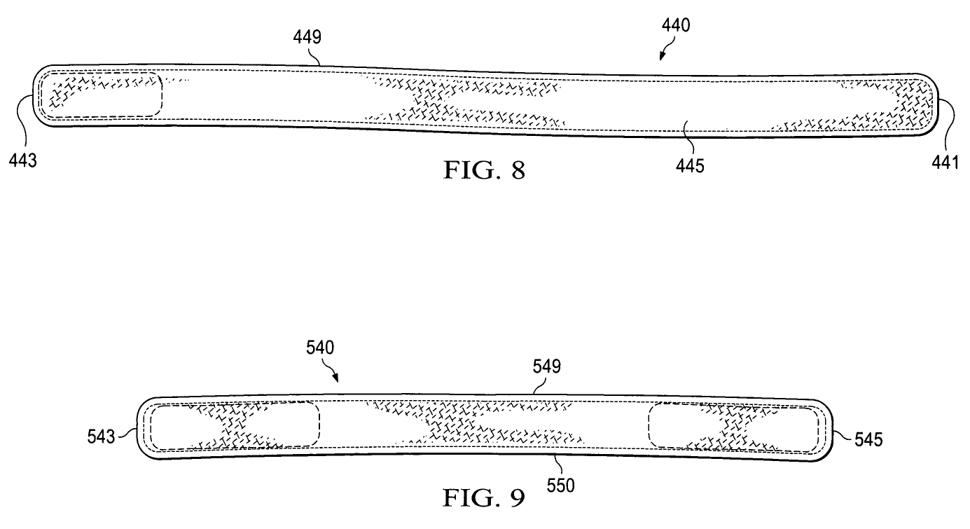

FIG. 8 illustrates a side view of a first L-shaped deformable pouch 440 which includes a hollow deformable housing which includes a front end panel 441, a back end panel 443, a top panel 445 and the first and second side panels 449, 450.

FIG. 9 illustrates a side view of a second L-shaped deformable pouch 540 which includes a hollow deformable housing which includes a front end panel 541, a back end panel 543, a top panel 547 and the first and second side panels 549, 550.

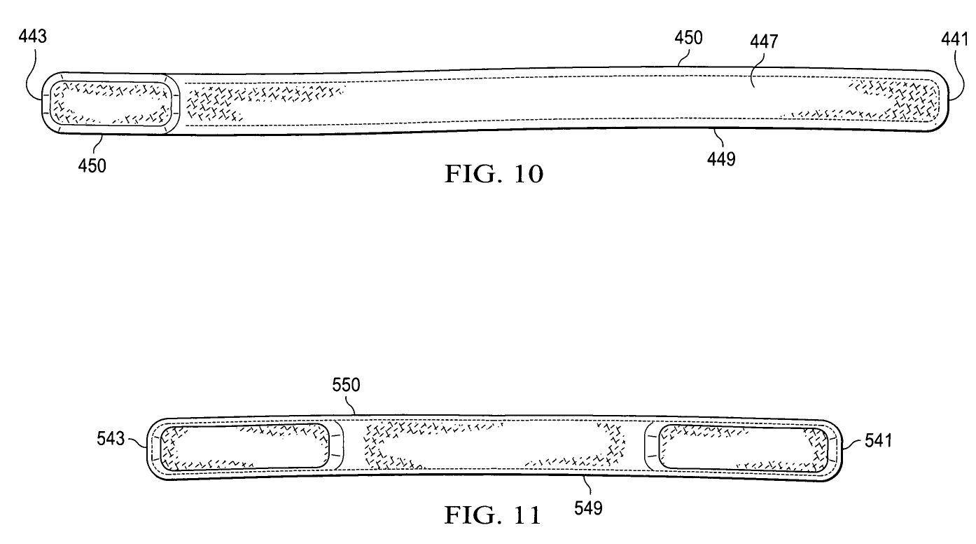

FIG. 10 illustrates a side view of a first L-shaped deformable pouch 440 which includes a hollow deformable housing which includes a front end panel 441, a back end panel 443, a bottom panel 447 and the first and second side panels 449, 450.

FIG. 11 illustrates a side view of a second L-shaped deformable pouch 540 which includes a hollow deformable housing which includes a front end panel 541, a back end panel 543, a bottom panel 547 and the first and second side panels 549, 550.

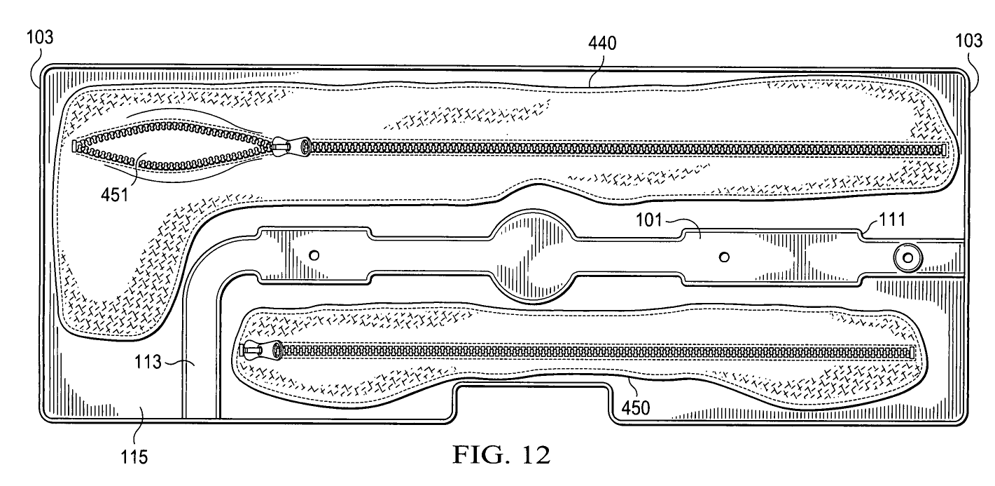

FIG. 12 illustrates the first and second L-shaped deformable pouches 441, 551 used in conjunction with the rigid saddlebag 100. The pouches have approximately the same dimensions as the storage area of the rigid saddle bags.

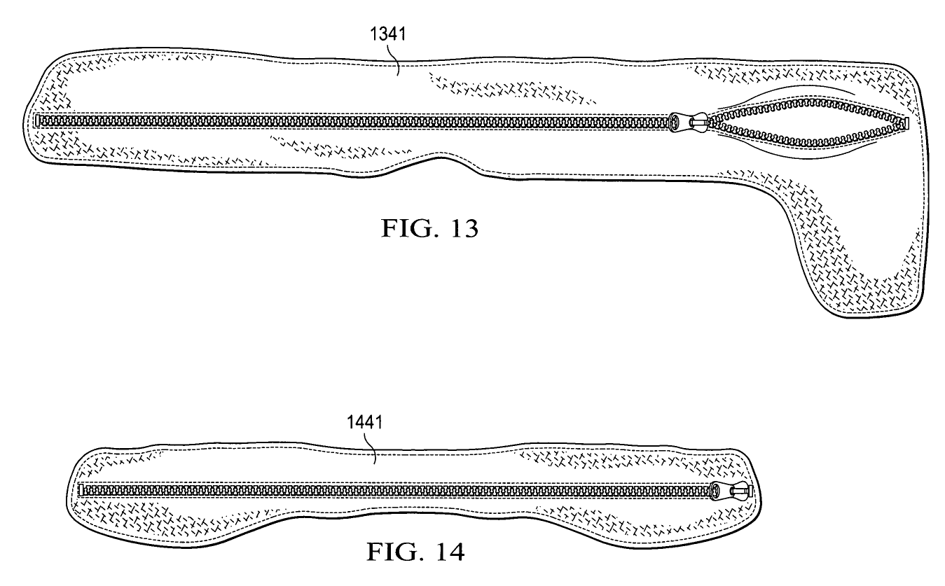

FIG. 13 illustrates a top view of a third L-shaped deformable pouch 1341 which is substantially a mirror image of the first L-shaped deformable pouch 441. The third L-shaped deformable pouch can be used in cooperation with an opposing saddlebag.

FIG. 14 illustrates a top view of a fourth L-shaped deformable pouch 1441 which is substantially a mirror image of the second L-shaped deformable pouch 551. The fourth L-shaped deformable pouch can be used in cooperation with an opposing saddlebag.

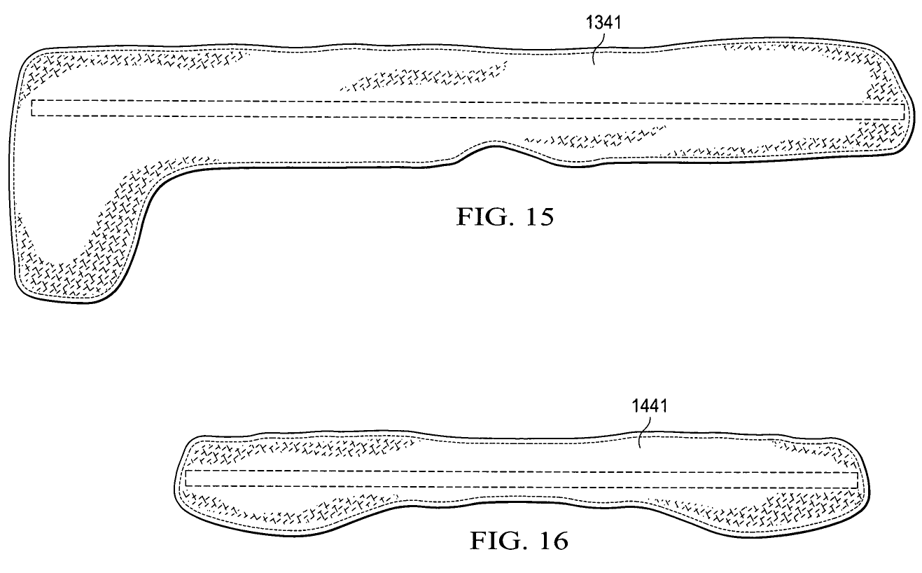

FIG. 15 illustrates a bottom view of the third L-shaped deformable pouch 1341.

FIG. 16 illustrates a bottom view of the fourth L-shaped deformable pouch 1441.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A pouch for being used with a rigid saddle bag, comprising:
a first end panel;
a second end panel;
a top panel between the first and panel and the second end panel;
a bottom panel between the first and panel and the second end panel;
a first and second substantially L-shaped side panel between the top and bottom panels;
wherein the rigid saddlebag includes a projecting member to define a first storage area and a second storage area and wherein the pouch is adapted to fit within the first storage area or the second storage area of the rigid saddlebag.

2. A pouch for being used with a rigid saddle bag as in claim 1, wherein the projecting member includes a longitudinal portion.

3. A pouch for being used with a rigid saddle bag as in claim 1, wherein the projecting member includes a traverse portion.

4. A pouch for being used with a rigid saddle bag as in claim 1, wherein the pouch is deformable.

5. A pouch for being used with a rigid saddle bag as in claim 1, wherein the pouch includes any opening to an interior area of the pouch.

6. A pouch for being used with a rigid saddle bag as in claim 1, wherein the pouch is formed from leather.

7. A pouch for being used with a rigid saddle bag as in claim 1, wherein the pouch is formed from plastic.

8. A pouch for being used with a rigid saddle bag as in claim 1, wherein the pouch has approximately the same dimensions as the storage area.

9. A pouch for being used with a rigid saddle bag as in claim 1, wherein the pouch is formed from vinyl.
